(19) United States
(12) Patent Application Publication
(10) Pub. No.: US 2021/0169204 A1
(43) Pub. Date: Jun. 10, 2021

(54) ADAPTIVE ASSISTED GRIP APPARATUS

(71) Applicant: Dropsy Redhead Designs, LLC., Dacula, GA (US)

(72) Inventor: Jenna Key, Dacula, GA (US)

(73) Assignee: Dropsy Redhead Designs, LLC., Dacula, GA (US)

(21) Appl. No.: 16/744,216

(22) Filed: Jan. 16, 2020

Related U.S. Application Data
(60) Provisional application No. 62/943,747, filed on Dec. 4, 2019.

(51) Int. Cl. A45F 5/00; A44C 5/00; A47G 21/02; B26B 3/02; A47G 21/04

(52) U.S. Cl. CPC A45F 5/00; A44C 5/0007; A47G 21/04; B26B 3/02; A45F 2005/008; A47G 21/023

(57) ABSTRACT

Implementations of an adaptive assisted grip apparatus are provided. In some implementations, the adaptive assisted grip apparatus comprises a holder and a wrist strap.

In some implementations, a method of using the adaptive assisted grip apparatus comprises inserting a makeup applicator or other suitable item into the holder, placing the wrist strap around a user's wrist, grasping and holding the makeup applicator or other suitable item using the holder, and using the wrist strap to prevent the makeup applicator or other suitable item inserted in the holder from falling to the floor/ground or otherwise being dropped if/when the user loses grip of the holder.

### CROSS REFERENCE TO RELATED APPLICATION

This application claims the benefit of U.S. Patent Application Ser. No. 62/943,747, which was filed on Dec. 4, 2019, and is incorporated herein by reference in its entirety.

### TECHNICAL FIELD

This disclosure relates to implementations of an adaptive assisted grip apparatus.

### BACKGROUND

For those suffering with arthritis and other ailments that affects fine motor coordination, putting on make-up can be problematic. For example, putting on mascara and lipstick can be difficult because it can be difficult to grab and hold on to the applicator tube. Persons with fine motor skill problems drop items frequently. However, there does not exist an apparatus configured to help a person with grabbing make-up applicators or other items and holding on to and preventing such items from falling to the floor or otherwise being dropped.

### BRIEF DESCRIPTION OF THE DRAWINGS

FIG. 1 illustrates an example use of an adaptive assisted grip apparatus according to the present disclosure.

FIGS. 2-9 illustrate implementations of an example adaptive assisted grip apparatus according to the present disclosure.

### DETAILED DESCRIPTION

Implementations of an adaptive assisted grip apparatus are provided. In some implementations, the adaptive assisted grip apparatus comprises a holder and a wrist strap.

In some implementations, the adaptive assisted grip apparatus is configured to help a user to grab a make-up applicator or other suitable item. In some implementations, the adaptive assisted grip apparatus is configured to help the user to hold on to and/or prevent such item from falling to the floor/ground or otherwise being dropped.

In some implementations, a method for using the adaptive assisted grip apparatus comprises inserting a makeup applicator or other suitable item into the holder, placing the wrist strap around a user's wrist, grasping and holding the makeup applicator or other suitable item using the holder, and using the wrist strap to prevent the makeup applicator or other suitable item inserted in the holder from falling to the floor/ground or otherwise being dropped if/when the user loses grip of the holder.

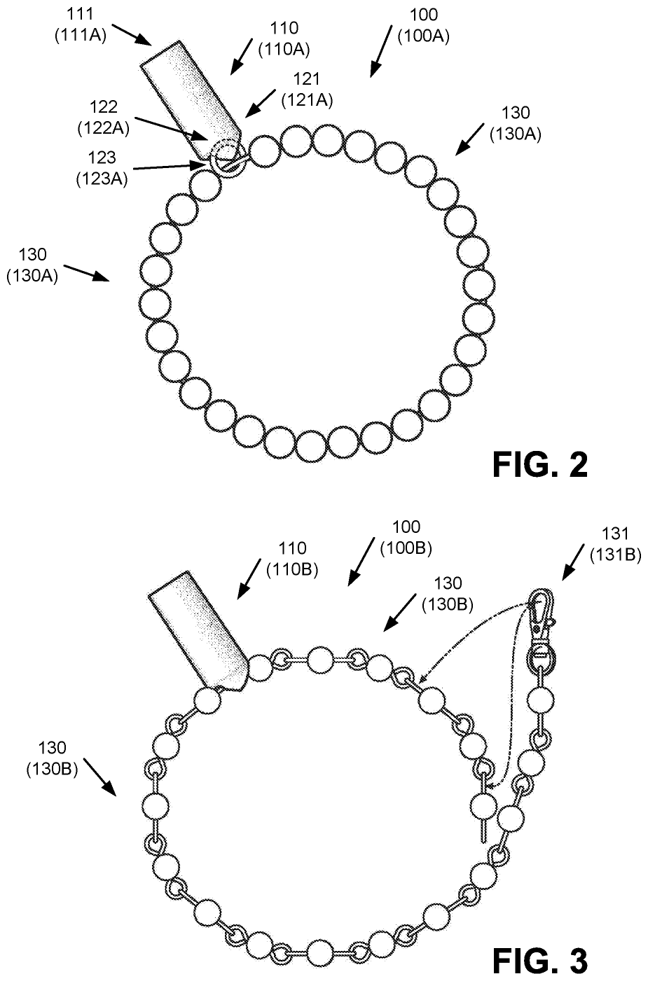

FIGS. 2-9 illustrate implementations of an example adaptive assisted grip apparatus 100 according to the present disclosure. As shown in FIG. 2, in some implementations, the adaptive assisted grip apparatus 100 (100A) comprises a holder 110 (110A) and a wrist strap 130 (130A).

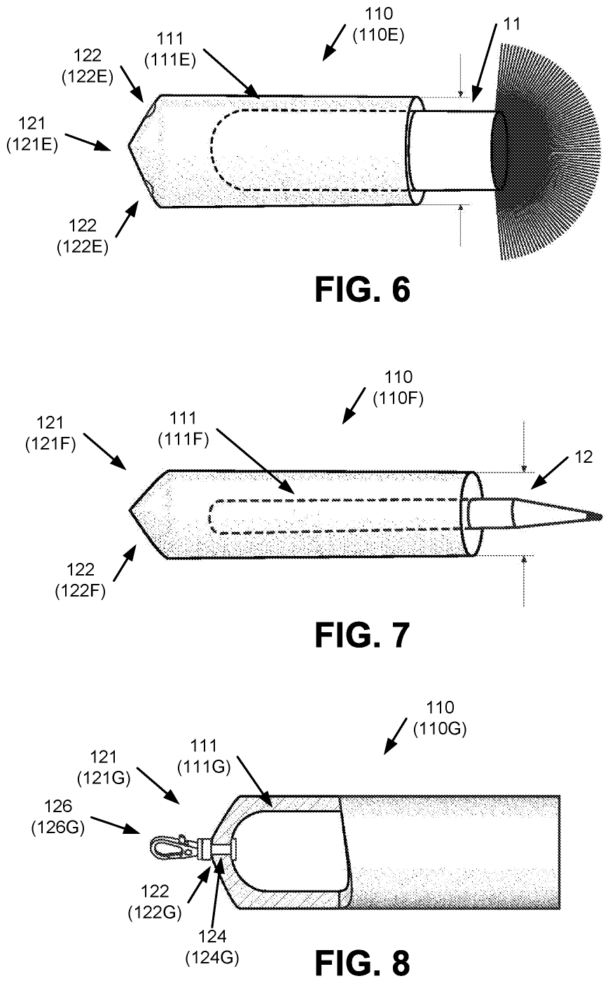

As shown in FIGS. 6 and 7, in some implementations, the holder 110 comprises an opening 111 (111E, 111F). As shown in FIGS. 2, 6, 8, and 9, in some implementations, the holder 110 (110A, 110E, 110G, 110H) comprises an attachment portion 121 (121A, 121E, 121G, 121H).

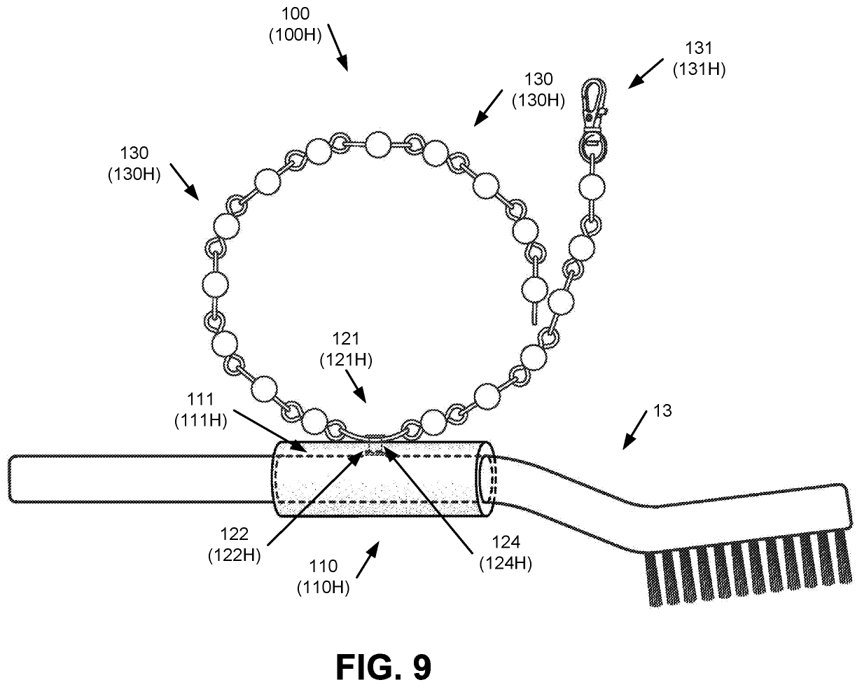

As shown in FIGS. 6 and 7, in some implementations, the opening 111 extends through at least a portion of the holder 110. As shown in FIG. 9, in some implementations, the opening 111 (111H) may fully extend through the holder 110. In some implementations, the opening 111 may extend through the holder 110 in any other suitable configuration.

In some implementations, the holder opening 111 extends parallel or generally parallel to the length (e.g., along the longest dimension) of the holder 110. In some implementations, the opening 111 may extend in any other suitable configuration with respect to the holder 110.

As shown in FIGS. 6, 7 and 9, in some implementations, the holder opening 111 is configured to receive at least a portion of a makeup applicator 11, 12, 13. For example, in some implementations, the opening 111 may be configured to receive an end portion of a makeup applicator 11, 12, 13. In some implementations, the opening 111 may be configured to receive any other suitable portion of a makeup applicator 11, 12, 13.

As shown in FIG. 6, in some implementations, the makeup applicator 11 may be a lipstick tube. As shown in FIG. 7, in some implementations, the makeup applicator 12 may be a makeup pencil, such as for eyeliner, mascara, lipstick, etc. As shown in FIG. 9, in some implementations, the makeup applicator 13 may be a makeup brush, such as for mascara. In some implementations, the makeup applicator may be any other suitable type of makeup applicator.

In some implementations, the holder opening 111 may be configured to receive at least a portion of any other suitable item. For example, in some implementations, the opening 111 may be configured receive at least a portion of a utensil, such as a spoon, fork, or knife.

As shown in FIG. 6, in some implementations, the holder attachment portion 121 comprises an opening 122 (122E). As shown in FIG. 2, in some implementations, the attachment portion 121 may further comprise a ring 123 (123A) or similar connecting component. As shown in FIGS. 8 and 9, in some implementations, the attachment portion 121 may further comprise a pin 124 (124G, 124H) or similar connecting component. As shown in FIG. 8, in some implementations, the attachment portion 121 may further comprise a snap hook 126 (126G) or similar connecting component.

As shown in FIGS. 2 and 6, in some implementations, the attachment opening 122 fully extends through a portion of the holder 110. As shown in FIGS. 8 and 9, in some implementations, the opening 122 may extend through at least a portion of the holder 110. In some implementations, the opening 122 may extend through the holder 110 in any other suitable configuration.

As shown in FIGS. 2, 6, and 9, in some implementations, the attachment opening 122 extends perpendicular or generally perpendicular to the length of the holder 110 and/or to the holder opening 111. As shown in FIG. 8, in some implementations, the opening 122 may extends parallel or generally parallel to the length of the holder 110 and/or to the holder opening 111. In some implementations, the opening 111 may extend in any other suitable configuration with respect to the holder 110 and/or to the holder opening 111.

As shown in FIGS. 3-5, in some implementations, the attachment opening 122 (122B, 122C, 122D) is configured to receive the wrist strap 130 (130B, 130C, 130D) of the adaptive assisted grip apparatus 100 (100B, 100C, 100D) such that the wrist strap 130 extends through the holder opening 111 and is thereby connected to the holder 110. In some implementations, the strap 130 may be thereby moveably connected to the holder 110 such that the strap 130 can rotate or otherwise move through or about the opening 111. In some implementations, the strap 130 is thereby connected to the holder 110 such that the strap 130 can support the holder 110 to prevent the holder 110 from falling to the floor/ground or otherwise being dropped, such as while holding a makeup applicator or other suitable item in the holder opening 111.

As shown in FIG. 2, in some implementations, the ring 123 extends through the attachment opening 122 such that the ring 123 is connected to the holder 110. In some implementations, the ring 123 may be thereby moveably connected to the holder 110 such that the ring 123 can rotate or otherwise move through or about the opening 122.

As shown in FIG. 2, in some implementations, the ring 123 is configured to receive the wrist strap 130 such that the strap 130 extends through the ring 123 and is thereby connected to the ring 123 and coupled to the holder 110. In some implementations, the strap 130 may be thereby moveably connected to the ring 123 such that the strap 130 can rotate or otherwise move through or about the ring 123. In some implementations, the strap 130 is thereby coupled to the holder 110 such that the strap 130 can support the holder 110 to prevent the holder 110 from falling to the floor/ground or otherwise being dropped, such as while holding a makeup applicator or other suitable item in the holder opening 111.

As shown in FIGS. 8 and 9, in some implementations, the pin 124 extends through the attachment opening 122 such that the pin 124 is connected to the holder 110. In some implementations, the pin 124 may be thereby moveably connected to the holder 110 such that the pin 124 can rotate or otherwise move through or about the opening 122.

As shown in FIG. 9, in some implementations, the pin 124 is configured to receive and/or otherwise connect to the wrist strap 130 such that the strap 130 extends through the pin 124 and/or is otherwise connected to the pin 124 and thereby coupled to the holder 110. In some implementations, the strap 130 may be thereby moveably connected to the pin 124 such that the strap 130 can rotate or otherwise move through or about the pin 124. In some implementations, the strap 130 is thereby coupled to the holder 110 such that the strap 130 can support the holder 110 to prevent the holder 110 from falling to the floor/ground or otherwise being dropped, such as while holding a makeup applicator or other suitable item in the holder opening 111.

As shown in FIG. 8, in some implementations, the snap hook 126 is connected or otherwise attached to the pin 124. In some implementations, the snap hook 126 may be thereby moveably connected to the pin 124 and/or the holder 110 such that the snap hook 126 can rotate or otherwise move with respect to the pin 124 and/or the opening 122.

As shown in FIG. 8, in some implementations, the snap hook 126 is configured to receive the wrist strap 130 such that the strap 130 extends through the snap hook 126 and is thereby connected to the snap hook 126 and coupled to the holder 110. In some implementations, the strap 130 may be thereby moveably connected to the snap hook 126 such that the strap 130 can rotate or otherwise move through or about the snap hook 126. In some implementations, the strap 130 is thereby coupled to the holder 110 such that the strap 130 can support the holder 110 to prevent the holder 110 from falling to the floor/ground or otherwise being dropped, such as while holding a makeup applicator or other suitable item in the holder opening 111.

In some implementations, the snap hook 126 is configured to be removably connected to the wrist strap 130. For example, in some implementations, the snap hook 126 can be opened/closed to connect or remove the wrist strap 130.

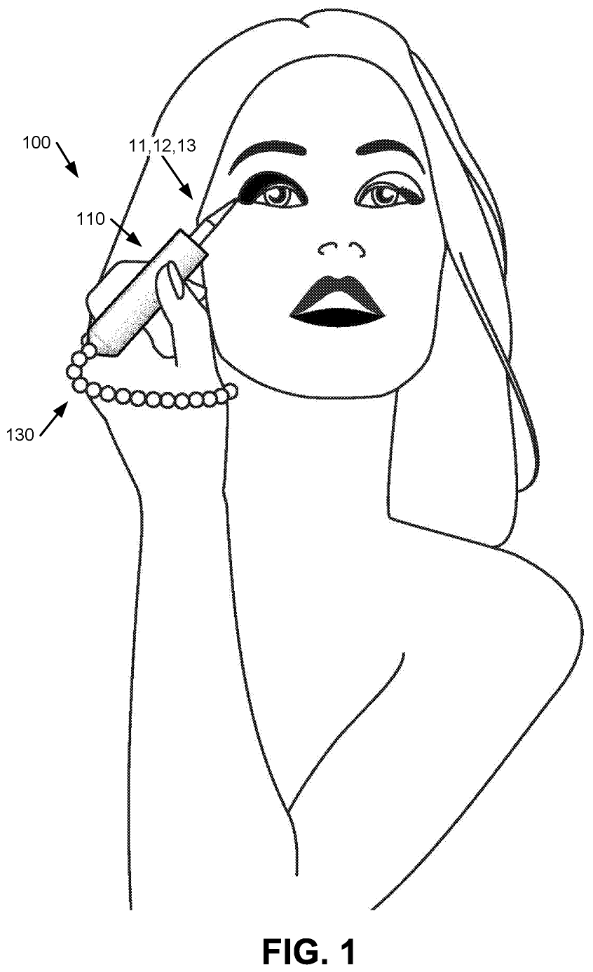

FIG. 1 illustrates an example use of an adaptive assisted grip apparatus 100 according to the present disclosure. As shown in FIG. 1, in some implementations, the holder 110 is configured such that the width of the holder 110 is wide enough to aid a user in gripping a make-up applicator, such as a makeup applicator 11, 12, 13 described above. In some implementations, the holder 110 is configured such that any other suitable dimension of the holder 110 is sufficient to allow a user to grip or otherwise hold a make-up applicator.

In some implementations, the holder 110 is configured such that any suitable dimension of the holder 110, such as the width as described above, is sufficient to allow a user to grip or otherwise hold any other suitable item, such as a utensil as described above.

As shown in FIGS. 6, 7 and 9, in some implementations, the holder 110 is configured such that the holder opening 111 conforms to the shape of an inserted makeup applicator, such as a makeup applicator 11, 12, 13 described above. In some implementations, the holder 110 is so configured such that holder 110 clings to or otherwise engages the makeup applicator inserted into the opening 111 to hold or otherwise secure the applicator in the opening 111.

In some implementations, the holder 110 may be composed of a spongy, rubbery material that allows the holder 110 to conform to and hold a makeup applicator or other suitable item and to be held by a user as described above. In some implementations, the holder 110 may be composed of any other suitable material.

As shown in FIG. 2, in some implementations, the wrist strap 130 comprises a continuous or closed loop configuration of material. As shown in FIGS. 3-5 and 9, in some implementations, the wrist strap 130 comprises a separable or openable loop configuration of material. In some implementations, the wrist strap 130 may comprise any other suitable configuration of material.

In some implementations, the continuous loop wrist strap 130, such as shown in FIG. 2, is configured to be big enough to receive a user's hand therethrough and to encircle the user's wrist to allow the user to wear the wrist strap 130. For example, in some implementations, the continuous loop strap 130 may be configured to stretch. In some implementations, the continuous loop strap 130 may be configured to fit as described in other suitable way.

As shown in FIGS. 3 and 9, in some implementations, the separable loop wrist strap 130 may comprise a clasp (or snap hook) 131 or similar connecting component that is configured to allow the separable loop strap 130 to be opened and closed.

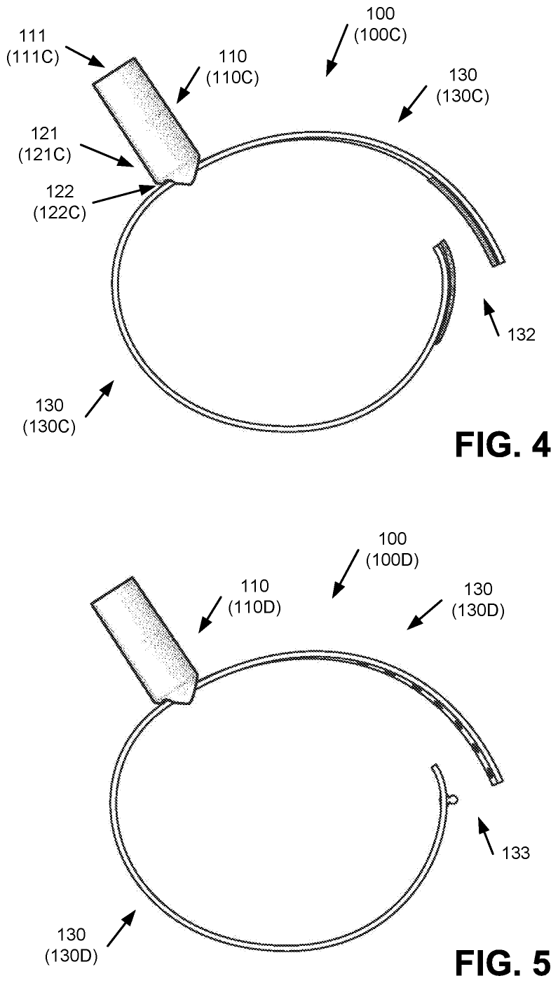

As shown in FIG. 4, in some implementations, the separable loop wrist strap 130 may comprise a hook and loop closure (e.g., Velcro®) 132 or similar connecting component that is configured to allow the separable loop strap 130 to be opened and closed.

As shown in FIG. 5, in some implementations, the separable loop wrist strap 130 may comprise a snap or button closure 133 or similar connecting component that is configured to allow the separable loop strap 130 to be opened and closed.

In this way, in some implementations, the separable loop strap 130 can be received over a user's hand and around the user's wrist to allow the user to wear the wrist strap 130 by opening and closing the above described connector 131, 132, 133.

In some implementations, the wrist strap 130 is configured to connect to and extend from the holder 110, such as described above with respect to the holder attachment portion 121.

In some implementations, the above described configurations of the separable loop strap 130 are configured to be adjustable in length to fit a user's wrist. For example, as shown in FIGS. 3 and 9, in some implementations, the separable loop strap 130 can be adjusted in length by connecting the clasp 130 to different positions on the strap 130 to vary the size of the loop.

Similarly, as shown in FIGS. 4 and 5, in some implementations, the separable loop strap 130 can be adjusted in length by connecting the closure 132, 133 at different positions on the strap 130 to vary the size of the loop. In some implementations, the separable loop strap 130 may be adjustable in length in any other suitable way to vary the size of the loop.

In some implementations, the wrist strap 130, such as the above described continuous and separable configurations, is configured to be worn on a user's wrist or similarly worn to prevent the holder 110 from falling to the floor/ground or otherwise being dropped, such as while holding a makeup applicator or other suitable item in the holder opening 111. For example, while wearing the wrist strap 130 and holding a makeup applicator or other suitable item by the holder 110, if a user loses grip of the holder 110, the wrist strap 130 prevents the applicator or other suitable item from falling to the ground, floor, other applicable surface.

In some implementations, the wrist strap 130, such as the above describe continuous loop configuration, may be composed of a material configured to stretch. In some implementations, the wrist strap 130, such as the above describe separable loop configuration, may be composed of a material configured not to or to minimally stretch. In some implementations, the wrist strap 130 may be composed of a material configured to have any other suitable features.

As shown in FIGS. 2, 3, and 9, in some implementations, the wrist strap 130 may be configured to have a decorative or otherwise appealing appearance. For example, in some implementations, the wrist strap 130 may comprise beads, pearls (e.g., imitation or simulated), or similar components. In some implementations, the wrist strap 130 may be configured to have any other suitable appearance.

In some implementations, the adaptive assisted grip apparatus 100 is configured to help a user to grab a make-up applicator or other suitable item. In some implementations, the adaptive assisted grip apparatus 100 is configured to help the user to hold on to and/or prevent such item from falling to the floor/ground or otherwise being dropped.

In some implementations, the adaptive assisted grip apparatus 100 comprises any suitable dimensions, such as the examples described above with respect to features of the adaptive assisted grip apparatus 100.

In some implementations, the adaptive assisted grip apparatus 100 is composed of any suitable materials, such as the above described examples.

In some implementations, the adaptive assisted grip apparatus 100 can have any suitable appearance, such as the above described examples.

In some implementations, an example method of using the adaptive assisted grip apparatus 100, with respect to the above-described FIGs., comprises inserting a makeup applicator, such as a makeup applicator 11, 12, 13, or other suitable item into the holder opening 111. In some implementations, an end portion of the makeup applicator is inserted in the opening 111 such that the makeup applicator can be used by holding the holder 110.

In some implementations, the method comprises placing the wrist strap 130 around a user's wrist. In some implementations, a continuous loop wrist strap 130 is stretched over the user's hand and released to encircle the user's wrist. In some implementations, a separable loop wrist strap 130 is opened and closed using the connector 131, 132, 133 to position the strap 130 around the user's wrist. In some implementations, the connector 131, 132, 133 is connected to different positions on the strap 130 to adjust the length of the strap 130 to fit around the user's wrist.

In some implementations, the method comprises grasping and holding the makeup applicator or other suitable item using the holder 110.

In some implementations, the method comprises using the wrist strap 130 positioned around the user's wrist to prevent the holder 110 and thereby the inserted makeup applicator or other suitable item from falling to the floor/ground or otherwise being dropped if/when the user loses grip of the holder 110.

The figures, including photographs and drawings, comprised herewith may represent one or more implementations of the adaptive assisted grip apparatus.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. An adaptive assisted grip apparatus, comprising a holder and a wrist strap, wherein:
the holder comprises an elongated piece of material having an item insertion opening and a wrist strap connection opening;
the item insertion opening extends at least partially into the holder parallel to the length of the holder;
the item insertion opening is configured to receive an item inserted at least partially into the opening, to conform to the shape of the inserted item, and to thereby hold the item within the opening;
the wrist strap connection opening extends at least partially into the holder;
the wrist strap connection opening is configured to couple the wrist strap to the holder such that the wrist strap prevents the holder from falling to a ground or floor surface when the wrist strap is worn by the user and the user drops the holder from the user's hand;
the holder is configured to be held in the hand of a user and to hold the item at least partially inserted into the item insertion opening such that the item can be held and used by the user by handling the holder;
the wrist strap comprises a loop of material coupled to the holder by the wrist strap opening and configured to be positioned around the user's wrist and worn by the user; and
the wrist strap is configured to couple to the holder and prevent the holder from falling to the ground or floor surface when the wrist strap is worn by the user and the user drops the holder from the user's hand;
whereby the adaptive assisted grip apparatus is configured to allow the user to grab and hold the item and to prevent the item from falling to the ground or floor surface when the user drops the item.

2. The adaptive assisted grip apparatus of claim 1, wherein the elongated piece of material is cylindrical shaped.

3. The adaptive assisted grip apparatus of claim 1, wherein the elongated piece of material comprises a spongy, rubbery textured material configured to be grasped and held by the user and to conform to the shape of the inserted item and thereby hold the item within the item insertion opening.

4. The adaptive assisted grip apparatus of claim 1, wherein the item insertion opening extends fully through the holder and is configured to receive the item inserted through the opening.

5. The adaptive assisted grip apparatus of claim 1, wherein the wrist strap connection opening extends fully through the holder perpendicular to the length of the holder and the wrist strap is connected to the holder by the wrist strap received and extending through the connection opening.

6. The adaptive assisted grip apparatus of claim 1, wherein the item comprises a facial makeup applicator.

7. The adaptive assisted grip apparatus of claim 1, wherein the item is a lipstick tube, a makeup pencil, or a makeup brush.

8. The adaptive assisted grip apparatus of claim 1, wherein the item comprises an eating utensil.

9. The adaptive assisted grip apparatus of claim 1, wherein the item is a spoon, a fork, or a knife.

10. The adaptive assisted grip apparatus of claim 1, wherein the wrist strap comprises a continuous loop of material configured to stretch and be moved over the user's hand and positioned around the user's wrist and worn by the user.

11. The adaptive assisted grip apparatus of claim 1, wherein the wrist strap comprises a separable loop of material and further comprises a clasp, and wherein the wrist strap is configured such that the wrist strap is separable by the clasp and configured to thereby be positioned around the user's wrist and worn by the user.

12. The adaptive assisted grip apparatus of claim 1, wherein the wrist strap comprises a separable loop of material and further comprises a hook and loop closure, and wherein the wrist strap is configured such that the wrist strap is separable by the closure and configured to thereby be positioned around the user's wrist and worn by the user.

13. The adaptive assisted grip apparatus of claim 1, wherein the wrist strap comprises a separable loop of material and further comprises a button closure, and wherein the wrist strap is configured such that the wrist strap is separable by the closure and configured to thereby be positioned around the user's wrist and worn by the user.

14. The adaptive assisted grip apparatus of claim 1, further comprising a ring, wherein the wrist strap connection opening extends fully through the holder perpendicular to the length of the holder, the ring is connected to the holder by the ring received and extending through the connection opening, and the wrist strap is coupled to the holder by the wrist strap received and extending through the ring.

15. The adaptive assisted grip apparatus of claim 1, further comprising a pin, wherein the pin is connected to the holder by the pin connected to the connection opening and the wrist strap is coupled to the holder by the wrist strap connected to the pin.

16. The adaptive assisted grip apparatus of claim 1, further comprising a pin and a snap hook, wherein the wrist strap connection opening extends parallel to the length of the holder opposite the item insertion opening, the pin is connected to the holder by the pin connected to the connection opening, the snap hook is connected to the pin, and the wrist strap is coupled to the holder by the wrist strap received and extending through the snap hook.

17. A method of using the adaptive assisted grip apparatus of claim 1, comprising:
inserting the item into the item insertion opening of the holder;
positioning the wrist strap around the user's wrist such that the wrist strap is worn by the user;
holding and using the inserted item by the user handling the holder;
preventing the holder from falling to the ground or floor surface by the wrist strap worn by the user when the user drops the holder.

18. An adaptive assisted grip apparatus, comprising a holder and a wrist strap, wherein:
the holder comprises an elongated cylindrical shaped piece of material having an item insertion opening and a wrist strap connection opening;
the item insertion opening extends at least partially into the holder parallel to the length of the holder;
the item insertion opening is configured to receive an item inserted at least partially into the opening, to conform to the shape of the inserted item, and to thereby hold the item within the opening, wherein the item comprises a facial makeup applicator;
the wrist strap connection opening extends at least partially into the holder;
the wrist strap connection opening is configured to couple the wrist strap to the holder such that the wrist strap prevents the holder from falling to a ground or floor surface when the wrist strap is worn by the user and the user drops the holder from the user's hand;
the holder is configured to be held in the hand of a user and to hold the item at least partially inserted into the item insertion opening such that the item can be held and used by the user by handling the holder;
the wrist strap comprises a loop of material coupled to the holder by the wrist strap opening and configured to be positioned around the user's wrist and worn by the user; and
the wrist strap is configured to couple to the holder and prevent the holder from falling to the ground or floor surface when the wrist strap is worn by the user and the user drops the holder from the user's hand;
whereby the adaptive assisted grip apparatus is configured to allow the user to grab and hold the item and to prevent the item from falling to the ground or floor surface when the user drops the item.

19. A method of using the adaptive assisted grip apparatus of claim 18, comprising:
inserting the item into the item insertion opening of the holder;
positioning the wrist strap around the user's wrist such that the wrist strap is worn by the user;
holding and using the inserted item by the user handling the holder;
preventing the holder from falling to the ground or floor surface by the wrist strap worn by the user when the user drops the holder.
